(19) United States
(12) Patent Application Publication
(10) Pub. No.: US 2020/0165000 A1
(43) Pub. Date: May 28, 2020

(54) ACTUATION DEVICE FOR AIRCRAFT EMERGENCY RAM AIR TURBINE SYSTEM

(71) Applicant: SAFRAN ELECTRICAL & POWER, Blagnac (FR)

(72) Inventor: Eric Joseph POLIN, Blagnac (FR)

(73) Assignees: SAFRAN ELECTRICAL & POWER, Blagnac (FR); SAFRAN ELECTRICAL & POWER, Blagnac (FR)

(21) Appl. No.: 15/767,125

(22) PCT Filed: Oct. 7, 2016
(86) PCT No.: PCT/FR2016/052602

§ 371 Date: Apr. 9, 2018

(30) Foreign Application Priority Data
Oct. 9, 2015 (FR) 1559629

(51) Int. Cl. B64D 41/00; F15B 15/19

(52) U.S. Cl. CPC B64D 41/007; F15B 15/19

(57) ABSTRACT

The invention relates to an actuation device (22) for a system (20) including an emergency ram air turbine (21). Said device includes a ram (22) extending along a longitudinal axis (29) and including: a cylinder (30) configured to be connected to an aircraft structure (23) and a piston (33) extending into the cylinder (30) and defining two chambers (31, 32) in the latter. The piston (33) is equipped with a rod (33a) partially extending outside the cylinder (30). Said rod portion extending outside the cylinder (30) is configured to be connected to the emergency ram air turbine (21). The piston (33) is configured to move, relative to the cylinder (30), between a retracted position and a released position, wherein the length of the portion (33b) of the rod (33a) extending outside the cylinder (30) is greater than in the retracted position. One (31) of the chambers of the cylinder (30) is equipped with at least one gas generator (34) configured, when the piston (33) is in the retracted position, to release gases into said chamber (31) so that the piston (33) moves, in the cylinder (30), from the retracted position to the released position as a result of a difference in pressure between the two chambers (31, 32) of the cylinder (30).

### GENERAL TECHNICAL FIELD

The present invention relates to an actuating device for an emergency ram air turbine system for an aircraft, particularly an airplane, comprising a jack.

### PRIOR ART

It is known to equip aircraft, particularly airplanes, with an emergency “ram air turbine”, which is used as an electrical energy source in the event of loss of the main electrical generators of the aircraft. This occurs for example in the event of a simultaneous failure of the engines of the aircraft. When operating, the emergency ram air turbine allows the production of the necessary electrical energy for the vital systems of the aircraft, such as for example the control and flight guidance system and actuators.

An aircraft emergency ram air turbine system known from the prior art is for example illustrated in FIG. 1. Such a system conventionally comprises an emergency ram air turbine 1, an aircraft structure 5, a hatch 7 and an actuating device 9 comprising a jack.

The emergency ram air turbine 1 comprises a mast 2, an electrical generator 3 and a turbine 4, the electric generator 3 and the turbine 4 being positioned at a first end 2a of the mast 2. The turbine 4 is coupled to the electrical generator 3 so that the rotation of the blades of the turbine 4 causes the production of electrical energy by the electrical generator 3.

The second end 2b of the mast 2 of the emergency ram air turbine 1 is further connected to the aircraft structure 5 through the jack 9 of the actuating device.

The jack 9 of the actuating device is shown in more detail in FIG. 2. It extends along a longitudinal axis 10 and comprises a cylinder 13 comprising a first chamber 14 and a second chamber 15, a piston 16 extending inside of the cylinder 13 between the first and the second chambers 14, 15, the piston 16 being provided with a rod extending partially outside of the cylinder 13 and a spring 17 positioned into the first chamber 14. The piston 16 moves with respect to the cylinder 13 under the influence of the spring 17 between a retracted position and a deployed position in which the length of the portion of the rod 16a extending in the exterior of the cylinder 13 is greater than in the retracted position.

The end 9a of the cylinder 13 opposite to the portion of the rod 16a extending outside of the cylinder 13 is connected to the aircraft structure 5 and, when the jack 9 is in the retracted position, to a hooking system 12. The end 9b of the rod 16a opposite to the piston 16, in other words the end 9b of the rod 16a which is located outside of the cylinder 13 is connected to the mast 2 of the emergency ram air turbine 1 and to a crank 11 for opening the hatch 7.

When the jack 9 is in the retracted position, the emergency ram air turbine 1 is housed inside of the aircraft. The jack 9 is held in the retracted position by the hooking system 12, the release of the jack 9 by the hooking system 12 causing the actuation of the jack 9. The release of the jack 9 by the hooking system 12 can be controlled manually by the pilot or automatically by the on-board system of the aircraft which detects for example the loss of the main electrical generators driven by the motors of the aircraft.

The actuation of the jack 9 causes the movement of the piston 16 and of the rod 16a from the retracted position to the deployed position, which allows the emergency ram air turbine 1 to be deployed toward the exterior of the aircraft and to simultaneously open the hatch 7 via the crank 11. When the jack 9 is in the deployed position, the turbine 4 of the emergency ram air turbine 1 is located outside of the aircraft so that a flow of air drives in rotation the blades of the turbine 4 and the electrical generator 3 produces the necessary electrical energy for the aircraft.

In the retracted position, the spring 17 is preloaded. Thus, when the hooking system 12 releases the jack 9, it also releases the potential energy of the spring 17 which is stored in the jack 9, causing the movement of the piston 16 and of the rod 16a from the retracted position to the deployed position and, as a result, the deployment of the emergency ram air turbine 1 and the opening of the hatch 7.

A considerable quantity of potential energy must therefore be stored in the spring 17 of the jack 9. This quantity of energy must in fact be sufficient to allow both the deployment of the emergency ram air turbine 1 and the opening of the hatch 7, and in particular for tolerating the aerodynamic forces which are applied to the emergency ram air turbine 1 and the hatch 7, when they are subjected to the exterior air flow.

Moreover, for the operation of retraction of the emergency ram air turbine 1, a hydraulic circuit 18 connecting the first and second chambers 13, 14 to a hydraulic pump 19 is provided. The oil contained into the first chamber 14 is pumped so that the piston 16 applies a force on the spring 17 and the jack 9 returns to its retracted position.

The forces generated by the spring 17 in the preloaded state must therefore necessarily be taken into account in dimensioning an emergency ram air turbine system, particularly an emergency ram air turbine 1, a jack 9 and a hooking system 12 which resists such forces.

However, considering forces generated by the spring 17 in the preloaded state, this leads to a considerable increase in the mass of the emergency ram air turbine system, which is contrary to the desire of aircraft manufacturers to reduce the mass of aircraft.

There is therefore a need to propose an emergency ram air turbine system with a lower mass.

### PRESENTATION OF THE INVENTION

The present invention responds to this need by proposing an actuating device for an aircraft emergency ram air turbine system comprising a jack and a gas generator for actuation of the jack so as to limit the forces internal to the jack and applied by the jack to the other components of the system, and thus reducing the mass of the jack and the other components of the system.

More precisely, the present invention has as its object an actuating device for a system comprising an emergency ram air turbine, said device comprising a jack extending along a longitudinal axis and comprising:

a cylinder configured to be connected to an aircraft structure or to the emergency ram air turbine,

a piston extending inside of the cylinder and defining two chambers therein, the piston being provided with a rod extending partially outside of the cylinder, said portion extending outside of the cylinder being configured to be connected to the emergency ram air turbine or to the aircraft structure, the piston being configured to move with respect to the cylinder between a retracted position and a deployed position, in which the length of the portion of the rod extending outside of the cylinder is greater than in the retracted position, one of the chambers of the cylinder being provided with at least one gas generator configured to, the piston being in the retracted position, release gases into said chamber, so that the piston moves in the cylinder from the retracted position to the deployed position under the influence of a pressure difference between the two chambers of the cylinder.

Such an actuating device has the advantage of implementing a gas generator for the actuation of the jack, which allows forces internal to said jack be limited, particularly in the retracted position, and thus to reduce its mass.

Preferably, the gas generator is a pyrotechnic generator or a hybrid generator.

Preferably, the gas generator is connected to an electrical circuit configured to supply the gas generator with the necessary electrical energy for releasing gases into the chamber of the cylinder in which it is situated, the electrical circuit being provided with a detection system configured to detect a failure of the electrical circuit.

Preferably, the second chamber is provided with an element configured to damp the piston, when the gas generator releases gases into the chamber of the cylinder in which it is situated and the piston moves from the retracted position to the deployed position.

More preferably, the second chamber is connected to a discharge duct configured to discharge the fluid contained in the second chamber, the discharge duct being provided with a restrictor configured to throttle the fluid discharged from the second chamber and thus to damp the piston, when the gas generator releases gases into the chamber of the cylinder in which it is situated.

As a variant, an elastic element is placed in the second chamber against the bottom of the cylinder, so that when the piston and the rod move from the retracted position to the deployed position, the piston compresses the elastic element against the bottom of the cylinder, thereby damping the piston.

Preferably, the cylinder further comprises a discharge opening configured to discharge gases released by the gas generator into the chamber of the cylinder in which it is situated, when the piston and the rod are in the deployed position.

More preferably, the discharge opening is arranged in the cylinder so as to be obstructed by the piston or to lead into the second chamber when the piston is in the retracted position, and to lead into the chamber of the cylinder in which the gas generator is situated when the piston is in the deployed position.

The present invention also has as its object a system comprising:

an aircraft emergency ram air turbine comprising a mast at a first end of which a turbine extends, said turbine being coupled to an electric generator,

an actuating device as previously described, comprising a jack extending along a longitudinal axis and comprising:

a cylinder connected to an aircraft structure or to an emergency ram air turbine,

a piston extending inside of the cylinder and defining two chambers therein, the piston being provided with a rod extending partially outside of the cylinder, said portion extending outside of the cylinder being connected to the emergency ram air turbine or to the aircraft structure, the piston being configured to move with respect to the cylinder between a retracted position and a deployed position, in which the length of the portion of the rod extending outside of the cylinder is greater than in the retracted position, one of the chambers of the cylinder being provided with at least one gas generator configured to, when the piston is in the retracted position, release gases into said chamber, so that the piston moves in the cylinder from the retracted position to the deployed position under the influence of a pressure difference between the two chambers of the cylinder.

Such a system has the advantage of implementing a gas generator for the actuation of the jack and hence the deployment of the emergency ram air turbine, which allows limiting the forces internal to the jack as well as the forces applied by the latter to the emergency ram air turbine and the aircraft structure, particularly in the retracted position, and thus reducing the mass of the system.

### PRESENTATION OF THE FIGURES

Other features, aims and advantages of the present invention will appear upon reading the detailed description that follows, and with reference to the appended drawings given by way of non-limiting examples and in which:

FIG. 1 (already described) is a perspective view of an aircraft emergency ram air turbine system according to the prior art;

FIG. 2 (already described) is a schematic view, in section, of a jack for actuation of the system illustrated in FIG. 1;

FIG. 3 is a perspective view of an aircraft emergency ram air turbine system according to one embodiment of the invention;

FIG. 4 is a schematic view, in section, of a jack for actuation of the system illustrated in FIG. 3,

FIGS. 5a and 5b are schematic views, in section, of a variant of the actuation jack illustrated in FIG. 4.

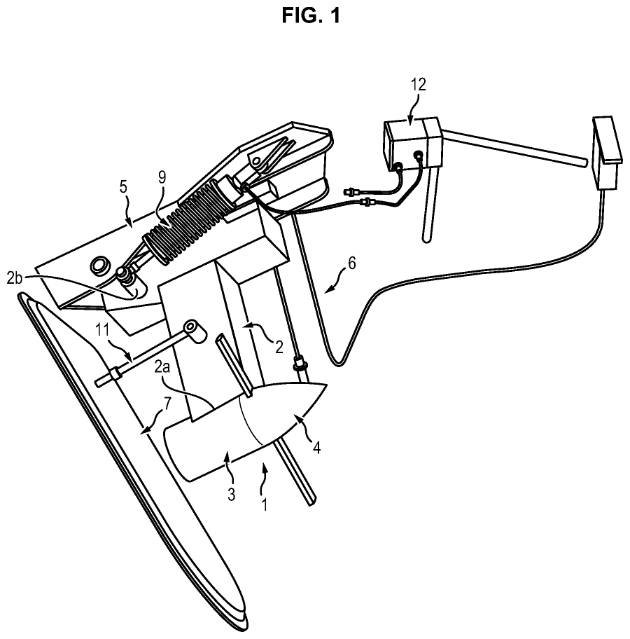

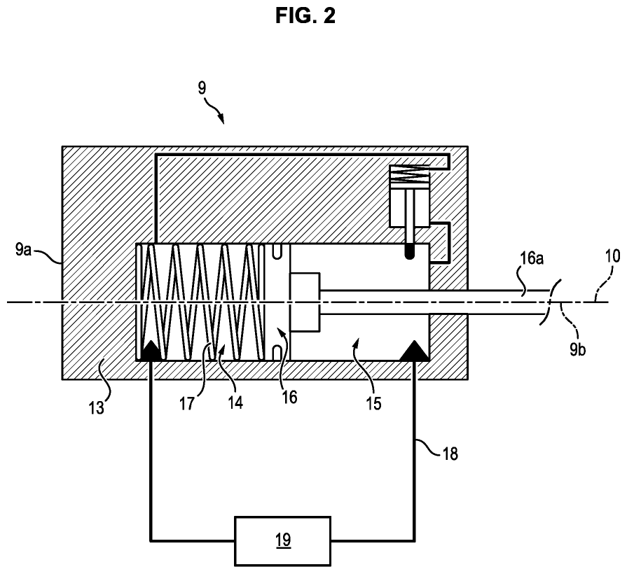

### DETAILED DESCRIPTION

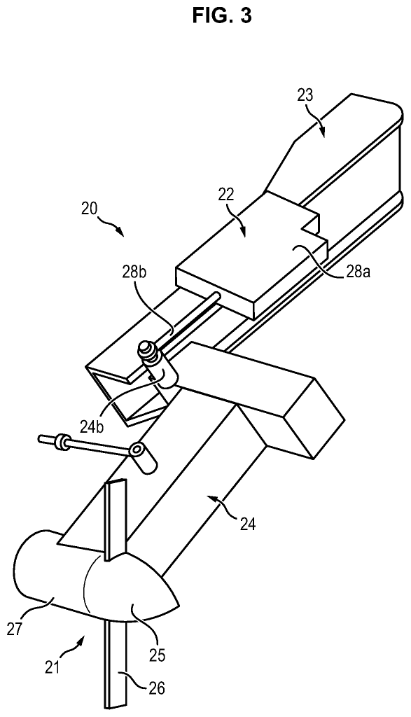

FIG. 3 shows an emergency ram air turbine system 20 of an aircraft, particularly of an airplane. The system 20 is for example positioned on the underbelly of the airplane, the nose of the airplane or the wing of the airplane.

The emergency ram air turbine system 20 comprises an emergency ram air turbine 21 (RAT), an actuating device for the emergency ram air turbine 21 including a jack 22 and an aircraft structure 23. The system 20 also comprises a hatch (not shown) provided in the fuselage of the airplane through which the emergency ram air turbine 21 is deployed to the exterior of the aircraft. It will be understood that, depending on the position of the emergency ram air turbine system 20 on the aircraft, the aircraft structure 23 in question is different.

The emergency ram air turbine 21 comprises a mast 24 at a first end 24a of which is positioned a turbine 25 equipped with blades 26. The turbine 25 is coupled to an electrical generator 27, so that the rotation of the blades 26 of the turbine 25 causes the production of electrical energy by the electrical generator 27. The electrical generator 27 is for example interposed between the first end 24a of the mast 24 and the turbine 25.

The second end 24b of the mast 24 is connected to the aircraft structure 23 through the actuating device 22.

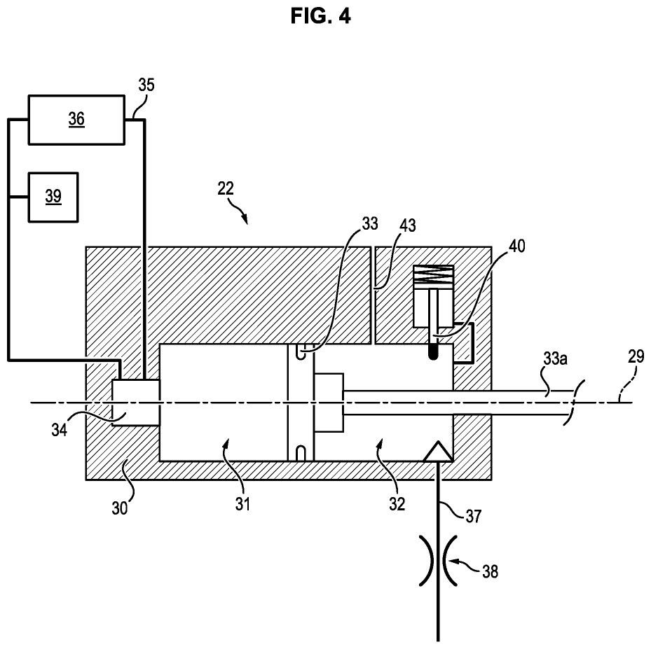

FIG. 4 shows in greater detail the jack 22 of the actuating device.

The jack 22 extends along a horizontal axis 29 and is connected by a first end 28a to the aircraft structure 23 and by a second end 28b to the mast 24 of the emergency ram air turbine 21. The jack 22 comprises:
a cylinder 30 connected to the aircraft structure 23 and comprising a first chamber 31 and a second chamber 32, and
a piston 33 extending inside of the cylinder 30 between the first and the second chamber 31, 32, the piston 33 being provided with a rod 33a extending partially outside of the cylinder 30, said portion extending outside of the cylinder 30 being connected to the emergency ram air turbine 21, the piston 33 further being configured to move with respect to the cylinder 30 between a retracted position and a deployed position in which the length of the portion of the rod 33a extending outside of the cylinder 30 is greater than in the retracted position. The portion of the rod 33a extending outside of the cylinder 30 is also connected to the hatch via a crank (not shown).

When the jack 22 is in the retracted position, the emergency ram air turbine 21 is housed inside of the aircraft. The jack 22 is actuated in its retracted position. The actuation of the jack 22 causes the movement of the piston 33 and of the rod 33a from the retracted position to the deployed position and hence the deployment of the emergency ram air turbine 21 toward the exterior of the aircraft. Simultaneously, the movement of the piston 33 and of the rod 33a causes the opening of the hatch via the crank so as to allow the emergency ram air turbine 21 to deploy to the exterior. When the jack 22 is in the deployed position, the hatch is open and the turbine 25 of the emergency ram air turbine 21 is located outside of the aircraft so that a flow of air drives in rotation the blades 26 of the turbine 25 and the electric generator 27 produces the necessary electrical energy for the aircraft.

The first chamber 31 of the cylinder 30 is further provided with at least one gas generator 34 configured to release gases into the first chamber 31 of the cylinder 30, when the jack 22 is actuated in the retracted position, so that the piston 33 moves in the cylinder 30 from the retracted position to the deployed position under the influence of a difference in pressure between the first and the second chamber 31, 32.

Thus, no potential energy is stored in the jack 22 in the retracted position, and no force generated by this potential energy is applied to the emergency ram air turbine 21 and the aircraft structure 23 in this position, so that the emergency ram air turbine system 20 can be dimensioned so as to reduce its mass.

Moreover, maintenance of the emergency ram air turbine system 20 is simplified in that only the recharging of the gas generator 34 is necessary to reactivate the system.

In addition, the operation of retraction of the emergency ram air turbine 21 into the interior of the aircraft is simplified. In fact, it is no longer necessary to preload a spring, nor to provide a hydraulic pumping system to retract the emergency ram air turbine 21. It becomes possible to carry out manual retraction of the emergency ram air turbine 21.

The gas generator 34 is for example a pyrotechnic gas generator. Such a pyrotechnic generate generally takes the form of a cartridge in which is provided a combustion chamber accommodating a pyrotechnic charge and an igniter actuated by transmission of electrical energy and configured to initiate the combustion of the pyrotechnic charge. The combustion of the pyrotechnic charge causes the release of gases which supply the first chamber 31 of the cylinder 30. The jack 22 is therefore actuated by the combustion of the pyrotechnic charge. For recharging the gas generator 34, only the cartridge of the gas generator 34 needs to be replaced.

According to a first variant, the gas generator 34 is a hybrid generator. Such a hybrid generator is differentiated from the pyrotechnic generator described above in that it associates inert gases stored in a reservoir independent of the cartridge with the pyrotechnic charge.

According to a second variant, the gas generator 34 is a cartridge containing gas under pressure, that is to say that the gases are compressed in the cartridge to a pressure greater than atmospheric pressure. In this variant, the gas generator 34 further comprises a valve arranged between the gas cartridge and the first chamber 31, so that when the valve is opened, the cartridge releases gases that it contains into the first chamber 31, thus causing the actuation of the jack 22.

Such gas generators are known for their use in vehicle airbag or evacuation toboggan systems. However, in these systems, the gas generators are used to inflate the airbag or toboggan, which are formed from a flexible envelope, so as to increase their volume. On the contrary, according to the invention, the gas generator 34 is associated with a cylinder 30 with rigid walls and the volume of which can therefore not vary during the release of gases by the gas generator 34. Structural constraints needing to be taken into account for the use of the gas generator 34 in the jack 22 therefore have no connection with those to be taken into account for the use of gas generators in an airbag or evacuation toboggan system. Moreover, whether in its application for airbags or evacuation toboggans, it is indispensable that the gas generator delivers a considerable quantity of gas in the shortest time possible. On the contrary, according to the invention, it is indispensable to control and to limit the speed of gas release into the first chamber 31 so as to obtain a movement of the piston 33 and the rod 33a and therefore a controlled deployment of the emergency ram air turbine 21 without risk of damage to the jack 22, to the emergency ram air turbine 21 or to the aircraft. Here too, the technical constraints to be taken into account for the use of the gas generator 34 in the jack 22 are different from those to be taken into account for the use of gas generators in an airbag or evacuation toboggan system.

The gas generator 34 is further connected to an electrical circuit 35 configured to actuate the release of gases into the first chamber 31 of the cylinder 30. The electrical circuit 35 makes it possible to feed electrical energy to the gas generator 34 by drawing this energy from batteries 36 stored in the aircraft. In particular, transiently, such batteries 36 are used to provide the necessary electrical energy to the aircraft until the emergency ram air turbine 21 is deployed.

When the gas generator 34 is a pyrotechnic or hybrid generator, the electrical circuit 35 allows the necessary electrical energy for the combustion of the pyrotechnic charge and therefore for the actuation of the jack 22 to be provided.

When the gas generator 34 is a cartridge containing gas under pressure, the electrical circuit 35 allows for example the actuation of the opening of the valve so as to release the gases into the first chamber 31 of the cylinder 30. As a variant, the valve can be actuated by means of a pyrotechnic gas generator configured to release the quantity of gas necessary for the opening of said valve. In this case, the actuation of the valve is therefore pneumatic. The gas generator is itself for example actuated by the electrical circuit 35.

The electrical circuit 35 can also be provided with a detection system 39 configured to detect a failure in the electrical circuit 35. This has the advantage of improving the reliability of the emergency ram air turbine system 20. The detection system 39 is for example configured, at regular time intervals, to send an analog signal at the input of the electrical circuit 35, to measure said analog signal downstream of the input of the electrical circuit 35, and to compare the analog signal sent and the measured analog signal. The analog signal is for example an electrical voltage in the electrical circuit 35. In this manner, it is possible to verify that the analog signal sent at the input of the electrical circuit 35 is retrieved correctly downstream in the electrical circuit 35 and therefore that the electrical circuit 35 is not open. It is thus ensured that there are no hidden faults in the electrical circuit 35 which would prevent the initiation of combustion of the pyrotechnic charge of the gas generator 34 at the desired moment.

In the example illustrated in FIG. 4, the jack 22 is further provided with a discharge duct 37 configured to discharge the fluid contained in the second chamber 32, the discharge duct 37 further being configured to damp the piston 33 when the gas generator 34 releases gases into the first chamber 31 of the cylinder 30. For that purpose, the evacuation duct 37 is for example provided with a restrictor 38 configured to throttle the fluid at the outlet of the second chamber 32 and thus damp the piston 33, when the gas generator 34 releases gases into the first chamber 31 of the cylinder 30. In fact, the throttling of the fluid allows additional head losses to be introduced into the discharge duct 37, which limit the increase in pressure in the second chamber 32 of the cylinder 30 when the piston 33 is moved toward the deployed position under the influence of the gases released by the gas generator 34. The throttling of the fluid thus makes it possible to control the increase in pressure in the second chamber 32 of the cylinder 30 and thus to ensure the damping of the piston 33.

The discharge duct 37 is for example configured to discharge the oil contained in the second chamber 32. In this case, the discharge duct 37 communicates with a hydraulic chamber (not shown). As a variant, the discharge duct 37 is configured to discharge the air contained in the second chamber 32 to a zone of the aircraft at atmospheric pressure overall, or to the exterior of the aircraft.

The discharge duct 37 and the restrictor 38 allow the adjustment of the time of displacement of the piston 33 and of the rod 33a from the retracted position to the deployed position, and thus avoid having the piston 33 arrive with too high a speed in abutment against the cylinder 30 (or the lug 40), causing damage to it.

The use of pyrotechnic or hybrid gas generators 34 also contributes to the control of the movement speed of the piston 33 and of the rod 33a. In fact, the greater the forces applied to the piston 33 through the rod 33a, namely the aerodynamic forces applied by the exterior air and the forces applied by the emergency ram air turbine 21 and by the hatch via the crank, the greater the pressure into the first chamber 31 and the more rapid is the combustion of the pyrotechnic charge and therefore the release of gases into the first chamber 31. The speed of the piston 33 and of the rod 33a is therefore elevated when the deployment of the turbine 21 is initiated. On the contrary, the smaller the efforts applied to the piston 33 via the rod 33a, which can be the case when the deployment of the emergency ram air turbine 21 is almost complete, the smaller the pressure into the first chamber 31 and the slower is the combustion of the pyrotechnic charge. The drop in pressure due to throttling of the fluid which is discharged from the second chamber 32 then predominates, thus ensuring the damping of the piston 33 and of the rod 33a.

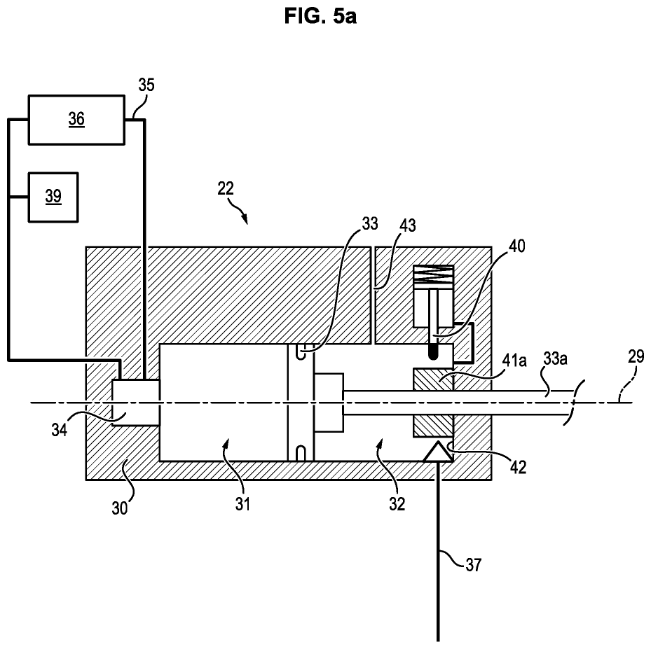

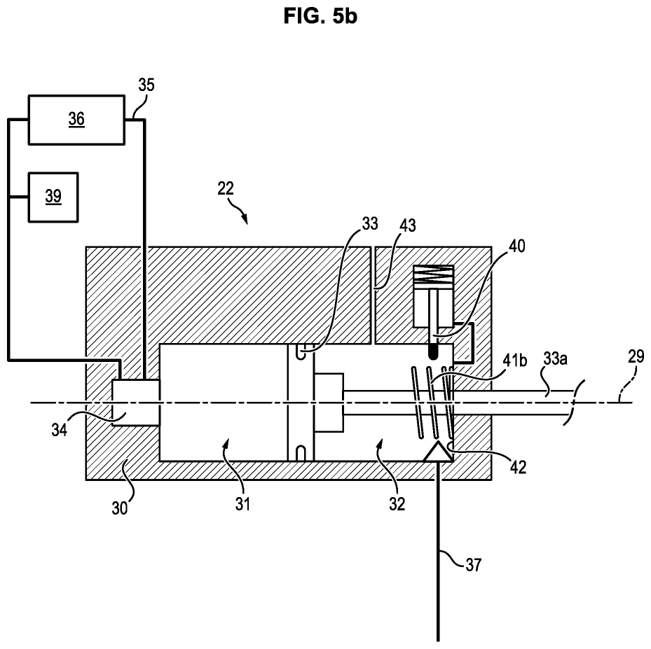

In a variant illustrated in FIGS. 5a and 5b, the piston 33 is damped through an elastic element 41 placed in the second chamber 32 of the cylinder 30, against the bottom 42 of the cylinder 30, so that when the piston 33 and the rod 33a move from the retracted position to the deployed position, the piston 33 compresses the elastic element against the bottom 42 of the cylinder 30. When the piston 33 and the rod 33a are in the retracted position, the elastic element is in the non-constrained state. When the piston 33 and the rod 33a are in the deployed position, the elastic element is in the compressed state. The elastic element 41 is for example an elastomer cylinder 41a attached to the bottom 42 of the cylinder 30 and provided with an axial opening through which the rod 33a extends (FIG. 5a). As a variant, the elastic element 41 is a spring 41b (FIG. 5b).

Several mutually independent gas generators 34 can be provided for releasing gases into the first chamber 31 of the cylinder 30. When the jack 22 comprises several gas generators 34, the latter can be assembled in parallel in the electrical circuit 35 so as to independently control their electrical power supply.

This has the advantage of ensuring that in the event of a failure of a gas generator 34, an n^{th} gas generator 34 can be used to replace it. The reliability of the emergency ram air turbine system 20 is thereby improved.

In the example illustrated in FIG. 4, the cylinder 30 further comprises a discharge opening 43 configured to discharge gases released by the gas generator 34 into the first chamber 31, when the piston 33 and the rod 33a are in the deployed position. For that purpose, the opening 43 is arranged in the wall of the cylinder 30 so as to be obstructed by the piston 33 or lead into the second chamber 32 when the piston 33 is in the retracted position, and to lead into the first chamber 31, when the piston 33 is in the deployed position. In this manner, in the deployed position, the pressure into the first chamber 31 is released so that the forces applied by the gases on the piston 33 are not maintained in this position. Thus, during dimensioning of the emergency ram air turbine system 20, the mass of the latter can also be decreased by taking into account this release of forces in the deployed position. The discharge opening 43 has smaller dimensions than the discharge duct 37 so as to avoid having the fluid contained in the second chamber 32 of the cylinder 30 passing preferentially into the discharge opening 43 and no longer into the discharge duct 37.

The emergency ram air system 20 previously described has the advantage of using a gas generator 34 for the actuation of the jack 22 and hence the deployment of the emergency ram air turbine 21, which limits the forces internal to said jack 22 and generated by the jack 22 on the emergency ram air turbine 21 and the aircraft structure 23, particularly in the retracted position.

1. An actuating device for a system comprising an emergency ram air turbine, said device comprising a jack extending along a longitudinal axis and comprising:
a cylinder configured to be connected to an aircraft structure or to the emergency ram air turbine,
a piston extending inside of the cylinder and defining two chambers therein, the piston being provided with a rod extending partially outside of the cylinder, said portion extending outside of the cylinder being configured to be connected to the emergency ram air turbine or to the aircraft structure, the piston being configured to move with respect to the cylinder between a retracted position and a deployed position, in which the length of the portion of the rod extending outside of the cylinder is greater than in the retracted position,
said actuating device being characterized in that one of the chambers of the cylinder is equipped with at least one gas generator configured to, the piston being in the retracted position, release gases into said chamber, so that the piston moves in the cylinder from the retracted position to the deployed position under the influence of a pressure difference between the two chambers of the cylinder.

2. The actuating device according to claim 1, wherein the gas generator is a pyrotechnic generator or a hybrid generator.

3. The actuating device according to claim 2, wherein the gas generator is connected to an electrical circuit configured to supply the gas generator with the necessary electrical energy for releasing gases into the chamber of the cylinder in which it is situated, the electrical circuit being provided with a detection system configured to detect a failure of the electrical circuit.

4. The actuating device according to claim 1, wherein the second chamber is provided with an element configured to damp the piston when the gas generator releases gases into the chamber of the cylinder in which it is situated and the piston moves from the retracted position to the deployed position.

5. The actuating device according to claim 4, wherein the second chamber is connected to a discharge duct configured to discharge the fluid contained in the second chamber, the discharge duct being provided with a restrictor configured to throttle the fluid discharged from the second chamber and thus to damp the piston, when the gas generator releases gases into the chamber of the cylinder in which it is situated.

6. The actuating device according to claim 4, wherein an elastic element is placed in the second chamber against the bottom of the cylinder so that when the piston and the rod move from the retracted position to the deployed position, the piston compresses the elastic element against the bottom of the cylinder.

7. The actuating device according to claim 1, wherein the cylinder further comprises a discharge opening configured to discharge gases released by the gas generator into the chamber of the cylinder in which it is situated, when the piston and the rod are in the deployed position.

8. The actuating device according to claim 7, wherein the discharge opening is arranged in the cylinder so as to be obstructed by the piston or to lead into the second chamber when the piston is in the retracted position, and to lead into the chamber of the cylinder in which the gas generator is situated when the piston is in the deployed position.

9. A system comprising an emergency ram air turbine comprising a mast at a first end of which a turbine extends, said turbine being coupled to an electric generator,
the system being characterized in that it further comprises an actuating device according to claim 1, said device comprising a jack extending along a longitudinal axis and comprising:
a cylinder connected to an aircraft structure or to the emergency ram air turbine,
a piston extending inside of the cylinder and defining two chambers therein, the piston being provided with a rod extending partially outside of the cylinder, said portion extending outside of the cylinder being connected to the emergency ram air turbine or to the aircraft structure, the piston being configured to move with respect to the cylinder between a retracted position and a deployed position, in which the length of the portion of the rod extending outside of the cylinder is greater than in the retracted position, one of the chambers of the cylinder being provided with at least one gas generator configured to, when the piston is in the retracted position, release gases into said chamber so that the piston moves in the cylinder from the retracted position to the deployed position under the influence of a pressure difference between the two chambers of the cylinder.
